(19) United States
(12) Patent Application Publication
(10) Pub. No.: US 2015/0302464 A1
(43) Pub. Date: Oct. 22, 2015

(54) SYSTEMS AND METHODS FOR AUDIENCE PERFORMANCE OPTIMIZATION USING CREDIT CARD DATA, HISTORICAL NETWORK TRANSACTION DATA, AND PROMOTION CONTACT DATA

(71) Applicant: MasterCard International Incorporated, Purchase, NY (US)

(72) Inventors: Marianne Iannace, North Salem, NY (US); Joanne Sterne, Chester (GB); Christine Wagner, New Hope, PA (US)

(73) Assignee: MasterCard International Incorporated, Purchase, NY (US)

(21) Appl. No.: 14/254,495

(22) Filed: Apr. 16, 2014

(51) Int. Cl. G06Q 30/02

(52) U.S. Cl. CPC G06Q 30/0244; G06Q 30/0201

(57) ABSTRACT

A method includes receiving a data set that represents payment card transactions of a set of cardholders during a current time period. The method further includes filtering the set of cardholders based on one or more spending characteristics exhibited by the set of cardholders and indicated by the payment card transactions during the current time period, to produce a subset of the cardholders. Still further, the method includes filtering the subset of cardholders based on one or more spending characteristics of the subset of cardholders during a historical time period that ended substantially prior to an ending point of the current time period, to produce an audience set of the cardholders. Promotional contact information relating to previous contacts with cardholders, and/or non-transactional account information (e.g., credit limits), may also be used in defining the audience set instead of twice filtering the set of cardholders based on spending habits.

### BACKGROUND

Promotional marketing campaigns are often employed to attempt to increase purchases or other consumer activity or to attempt to change consumer behavior in some way. Various well known types of promotional campaigns include “buy one—get one free” campaigns, rebate campaigns (“purchase product X and receive a rebate of Y dollars”), and so forth. One frequently addressed problem is how to define the audience for a promotional marketing campaign. It is well known that simply broadcasting a promotional offer to the general public or to a heterogeneous mailing list is likely to result in a great deal of waste in terms of marketing resources. Many proposals have been made regarding improvements in targeting or enhancing efficiency of promotional offer campaigns, but as the present inventors have recognized, these prior proposals have not exhausted the possibilities for efficient design of promotional offer campaigns or other marketing campaigns.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a conventional payment card system.

FIG. 2 is a diagram that schematically illustrates aspects of the present invention.

FIG. 3 is a block diagram representation of a computer system provided in accordance with some aspects of the invention to implement at least some of the functionality illustrated in FIG. 2.

FIG. 4 is a flow chart that illustrates a process that may be performed in the computer system of FIG. 3 in accordance with aspects of the present invention.

### DETAILED DESCRIPTION

In general, and for the purpose of introducing concepts of embodiments of the present invention, consumer spending habits are analyzed to produce a highly targeted promotional marketing campaign. Not only are current or recent spending habits considered, but in addition spending habits over at least one prior period are also taken into account to enhance the efficiency of the design of the campaign. At least one source of information about the consumers' spending habits may be transactions initiated by the consumers in a payment card system. The insights provided by combined analysis of both current and historical spending habits may be used to enhance audience selection for a promotional campaign and/or to improve the efficiency of the campaign in terms of the design elements of the campaign itself. One or more other sources of information may also be used to aid in selecting the audience, including information about previous promotional contacts with prospective audience members, and information about the prospective audience members' accounts apart from transaction information. The design elements for the campaign may include the nature of one or more incentives that are offered and/or what the consumers are required to do (e.g., achieving a certain level of purchases) in order to earn an incentive offered in the campaign.

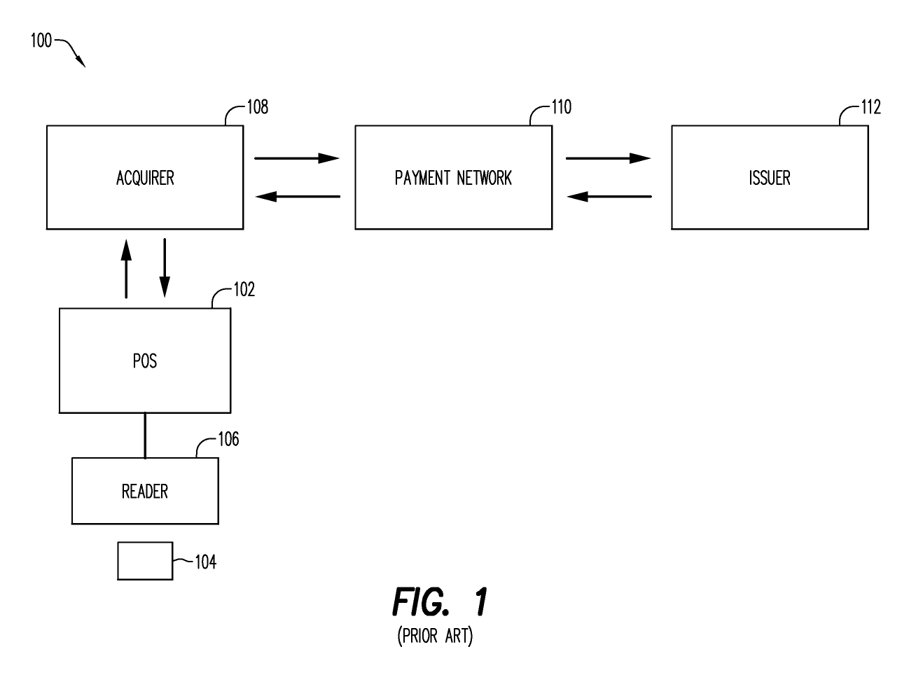

For background, a conventional card-based payment system (such as that operated by MasterCard International Incorporated, the assignee hereof) will now be described. FIG. 1 is a block diagram representation of such a system, which is generally indicated in the drawing by reference numeral 100. In particular, the representation of the payment system 100 in FIG. 1 reflects the flow of information and messaging for a single payment card transaction.

The transaction in question may originate at a POS (point of sale) device 102 located in a merchant store (which is not separately indicated). A payment card 104 is shown being presented to a reader component 106 associated with the POS device 102.

The payment card 104 is often implemented as a magnetic stripe card, although alternatively, or in addition, the payment card 104 may include capability for being read by proximity RF (radio frequency) communication with an integrated circuit (IC) chip (not separately shown) that is included in the card. The primary account number (PAN) for the payment card account represented by the payment card 104 may be stored on the magnetic stripe (not separately shown) and/or the IC chip (if present) for reading by the reader component 106 of the POS device 102.

In some installations, the reader component 106 may be configured to perform either or both of magnetic stripe reading and reading of IC chips by proximity RF communications. Thus, the payment card 104 may be swiped through a mag stripe reading portion (not separately shown) of the reader component 106, or may be tapped on a suitable surface of the reader component 106 to allow for proximity reading of its IC chip.

In some transactions, instead of a card-shaped payment device, such as the payment card 104, a suitable conventional payment-enabled mobile phone or a payment fob may be presented to and read by the reader component 106.

A computer 108 operated by an acquirer (acquiring financial institution) is also shown as part of the payment system 100 in FIG. 1. The acquirer computer 108 may operate to receive an authorization request for the transaction from the POS device 102. The acquirer computer 108 may route the authorization request via a payment network 110 to the server computer 112 operated by the issuer of the payment card account that is available for access by the payment card 104. The authorization response generated by the payment card issuer server computer 112 may be routed back to the POS device 102 via the payment network 110 and the acquirer computer 108.

The payment network 110 may be for example the well-known Banknet system operated by MasterCard International Incorporated, which is the assignee hereof

The components of the system 100 as depicted in FIG. 1 are only those that are needed for processing a single transaction. A typical payment system 100 now in use may include a considerable number of payment card issuers and their computers, a considerable number of acquirers and their computers, and numerous merchants and their POS devices and associated reader components. The system may also include a very large number of payment card account holders, who carry payment cards and/or other payment-enabled devices. Of course, in a typical payment system, a large volume of payment transactions may be handled simultaneously

In the course of receiving and relaying the authorization requests and responses, the payment network 110 may receive and store large quantities of transaction data, including for each one of many transactions, the PAN, the date and time of the transaction, the transaction total amount, the merchant, and the store location. This transaction data, referred to above and below as payment network transaction data, may advantageously be used and analyzed, according to aspects of the present invention, in audience selection and/or campaign design, in connection with a proposed promotional marketing campaign. However, the teachings of the present invention, as set forth herein, are not limited to campaign design that utilizes payment network transaction data.

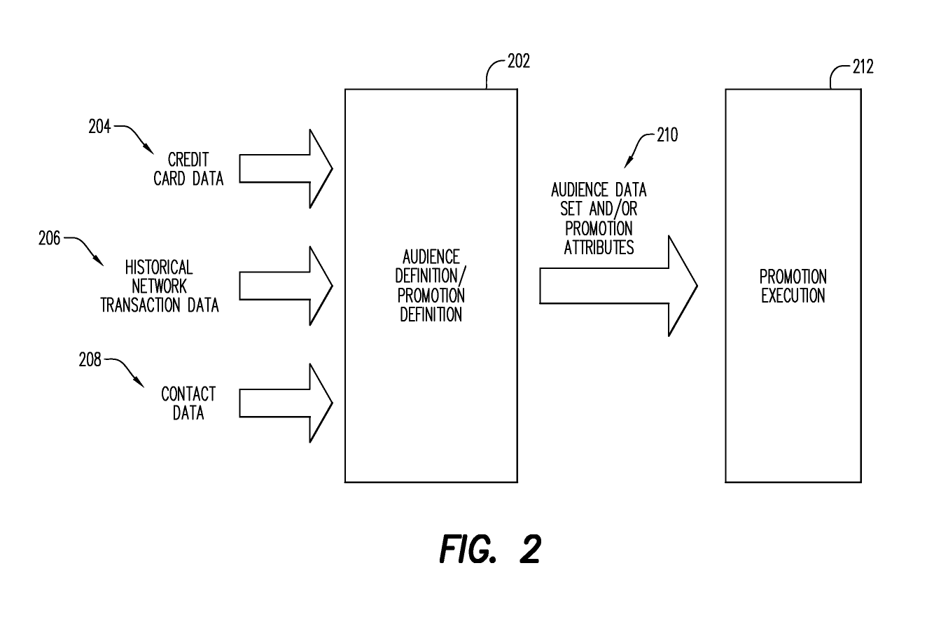

FIG. 2 is a diagram that schematically illustrates aspects of the present invention. Block 202 in FIG. 2 represents a central aspect of the invention, i.e., a data processing function that aids or provides guidance for and/or determines attributes of a promotional marketing campaign (sometimes also referred to herein as a “promotion”). Inputs to the promotion design function 202 may include credit card data (e.g., current data from a credit card issuer, where the current data may include transaction data and/or data about the cardholders' accounts apart from transaction data), as indicated at 204; historical payment network transaction data, as indicated at 206; and consumer contact data (e.g., one or more dates and/or descriptions of previous promotional contacts made with consumers), as indicated at 208. The output(s) (indicated at 210) from the promotion design function 202 may include either or both of a data set that represents the audience for the promotion and one or more attributes of the promotion.

Block 212 in FIG. 2 represents a function that executes the promotional marketing campaign based on the data 210 that is exported/output from the promotion design function 202.

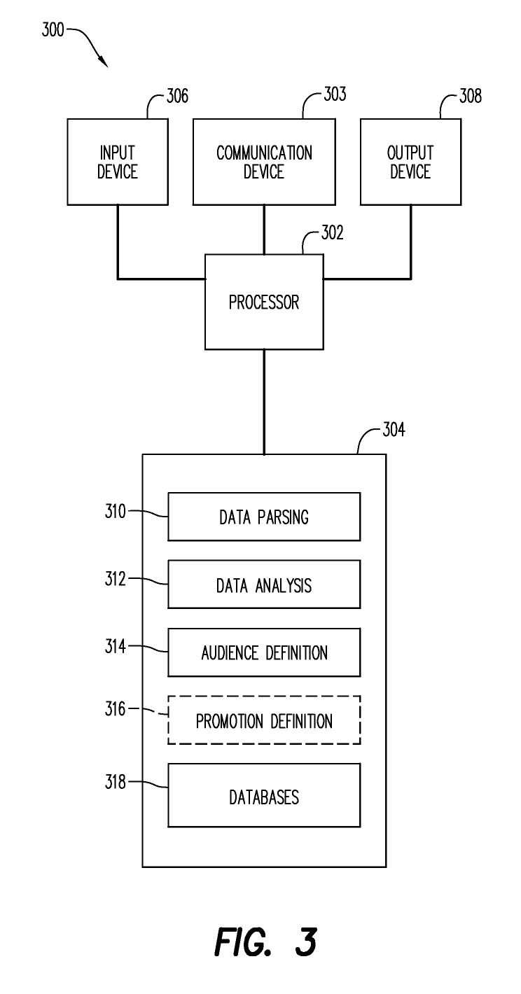

FIG. 3 is a block diagram representation of a computer system 300 provided in accordance with some aspects of the invention. The computer system 300, which will be referred to as a “promotion design computer”, may incorporate the functionality of at least the promotion design functional block 202 shown in FIG. 2.

The promotion design computer 300 may be conventional in its hardware aspects but may be controlled by software to cause it to function as described herein. The promotion design computer 300 may include a computer processor 302 operatively coupled to a communication device 303, a storage device 304, an input device 306 and an output device 308.

The computer processor 302 may be constituted by one or more conventional processors. Processor 302 operates to execute processor-executable steps, contained in program instructions described below, so as to control the promotion design computer 300 to provide desired functionality.

Communication device 303 may be used to facilitate communication with, for example, other devices (such as, for example, a separate computer—which is not shown—which embodies the promotion execution function 212 shown in FIG. 2, and/or one or more computers that supply the input data illustrated in FIG. 2). For example (and continuing to refer to FIG. 3), communication device 303 may comprise one or more communication ports (not separately shown), to allow the promotion design computer 300 to communicate with other computers.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 302. The programs comprise program instructions (which may be referred to as computer readable program code means) that contain processor-executable process steps of the promotion design computer 300, executed by the processor 302 to cause the promotion design computer 300 to function as described herein.

The programs may include one or more conventional operating systems (not shown) that control the processor 302 so as to manage and coordinate activities and sharing of resources in the promotion design computer 300, and to serve as a host for application programs (described below) that run on the promotion design computer 300.

The programs stored in the storage device 304 may also include a data parsing application program 310 that controls the processor 302 to enable the promotion design computer 300 to parse one or more of the data sets received as inputs by the promotion design computer 300. For example, the data parsing application program 310 may process the input data so that it is in an appropriate format for subsequent analysis by the promotion design computer 300.

Another program that may be stored in the storage device 304 is data analysis application program 312. The data analysis application program 312 may control the processor 302 to enable the promotion design computer 300 to perform data analysis, as described in more detail below, to aid in either or both of audience selection or designing of campaign attributes for the proposed promotional marketing campaign.

The storage device 304 may also store audience definition application program 314. The audience definition application program 314 may control the promotion design computer 300 to generate an output data set that represents a proposed audience for the promotional marketing campaign. At least in part the audience definition application program 314 may operate on the basis of analysis provided by the data analysis application program 312.

In some embodiments, the storage device 304 may further store an application program 316 that defines attributes of the promotion itself, including for example definition of (a) the audience or audience segments, (b) one or more incentives, and (c) prerequisites that will be required of one or more segments of the audience in order to qualify for an incentive or incentives offered in the promotion. (Block 316 is shown in phantom to indicate that in some embodiments, the promotion design computer 300 may only define the audience for the promotion but not any other attribute for the promotion such as incentives or prerequisites.)

The storage device 304 may also store, and the promotion design computer 300 may also execute, other programs, which are not shown. For example, such programs may include a reporting application, which may respond to requests from system administrators for reports on the activities performed by the promotion design computer 300. The other programs may also include, e.g., data communication software, database management software, device drivers, etc.

The storage device 304 may also store one or more databases 318 required for operation of the promotion design computer 300. Such databases may store, for example, at least on a temporary basis, the input data depicted in FIG. 2 (or processed versions thereof), as well as one or more output data sets to be exported from the promotion design computer 300. In other words, the databases 318 may include such data as is needed for the processing application programs depicted in FIG. 3.

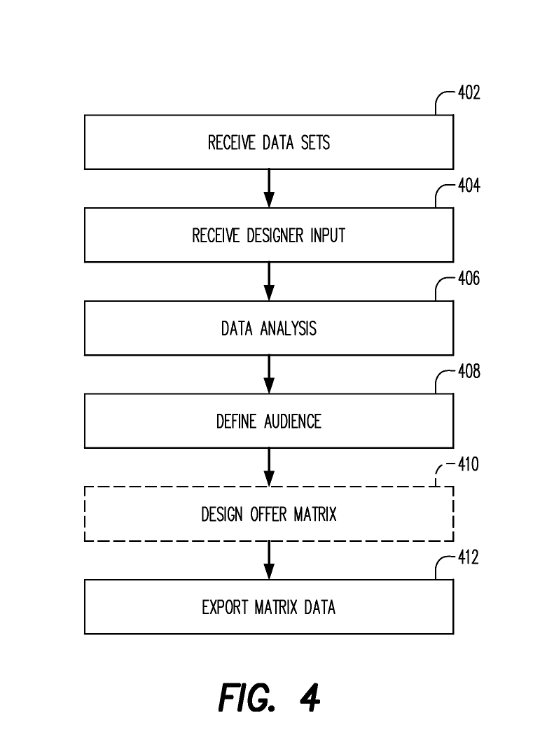

Further details of the application programs will be provided in the ensuing discussion of FIG. 4.

FIG. 4 is a flow chart that illustrates a process that may be performed in the promotion design computer 300 of FIG. 3 in accordance with aspects of the present invention. For convenience of discussion, the process of FIG. 4 will be described within an assumed context in which a financial institution that issues payment card accounts wishes to engage in a promotion to enhance usage by its cardholders of their payment card accounts. For example, the issuer in question could be the issuer 112 depicted in FIG. 1. In some embodiments, the issuer may retain a data analysis and marketing advisement department of the operator of the payment network 110 to aid the issuer in executing a focused, efficient marketing campaign. In such embodiments, the promotion design computer 300 may be operated by the payment network operator or a department or division thereof. As will be seen, one advantageous aspect for the issuer may be that the payment network operator can (via the promotion design computer 300) provide insights based on payment network transaction data, and particularly historical payment network transaction data. It should be understood that the assumed context for the discussion is not intended to limit the applicability of the teachings of this document.

At 402 in FIG. 4, the promotion design computer 300 receives one or more input data sets, such as those referred to above in connection with FIG. 3. To provide more details of some embodiments, the input data sets may include credit card data that the promotion design computer 300 may receive from a computer (not shown) operated by an issuer that desires to launch a promotional marketing campaign. The credit card data may include, for example, the PAN (primary account number) for the cardholder's payment card account, the type of card (e.g., debit/credit/gift card, etc.), the credit limit, how long it has been since the account was established, what reward program(s) is/are associated with the payment card account, what the current unpaid balance is for the account, what categories of transaction (e.g., types of merchants) have been charged to the account, what the total spending has been in the account during a recent period (e.g., the last billing cycle, or the last few billing cycles, and/or since the last billing cycle commenced), how much of the spending was at physical POS terminals and/or how much of the spending was online, whether the account is used for recurring payments, and if so, for how many, etc.

The credit card data may also, in some embodiments, represent payment card transactions for a current time period, which (for purposes of this description and the appended claims) refers to a time period that contains one, two or three months or portions thereof, or a shorter period, and that ended not more than one or two months prior to the time when the promotion design computer 300 receives the credit card information. It may be preferred, in some embodiments, that the current period data only include very recent transaction information. It will be appreciated that the credit card data indicates one or more spending habits and/or other spending characteristics of the cardholders represented in the credit card input data set.

Apart from the transaction data and the PANs, the other credit card input data may be referred to as non-transactional account information data.

In some embodiments, the transaction data for the current time period may come from a source other than the issuer, e.g., from the payment network.

Another input data set that may be received by the promotion design computer 300 at block 402 is historical payment network transaction data. For example, the promotion design computer 300 may receive this data set from a transaction data repository (not shown) that is maintained by the operator of the payment network 110 (FIG. 1). In some embodiments, this data set contains transaction data representing usage of payment card accounts issued by the issuer to cardholders included in the credit card data set. The period covered by this data set may, in some embodiments, begin about nine months to a year prior to the end date of the period. In some embodiments, the historical payment network transaction data may not be readily available to the issuer.

The period covered by the historical payment network transaction data may be referred to as a “historical time period” and may end substantially before (say a month or more prior to) the end point of the current time period.

Still another input data set may be a promotional contact information data set that provides information about previous promotional contacts that have been made to the individual cardholders represented by the credit card data input data set. In some embodiments, the promotion design computer 300 may receive this data set from a computer operated by the issuer. (Alternatively, the issuer may permit the payment network or another entity to retain this information for use in subsequent analysis.) This data set may contain, for example, information about one or more dates on which promotional contacts were made to the individual cardholders and/or data that indicates what type or types of promotional contacts were previously made to the cardholders.

Referring again to FIG. 4, processing may continue at block 404, in which the promotion design computer 300 may receive input from a human operator/promotional design specialist concerning what the issuer's objectives are for the proposed campaign. In some embodiments, the issuer's objectives may include, for example, increasing account usage among cardholders who are engaging in low levels of spending with their payment card accounts, increasing use of payment card accounts for recurring payments and/or getting cardholders to add new categories of purchases to the types of transactions that they have habitually engaged in. The input from the human operator received by the promotion design computer 300 at block 404 may not be limited to campaign objectives, but may also include, for example, proposed parameters for the campaign, such as the promotional budget (including, e.g., amounts to be spent on promotional communications and/or amount to be spent on incentives).

Processing may continue at 406, with the promotion design computer 300 performing one or more analyses on the data sets received at 402 and based at least in part on the human input received at 404. For example, in some embodiments, the promotion design computer 300 may filter the set of cardholders (e.g., typically the entire universe of cardholders for the issuer, or cardholders for a certain type of payment card account issued by the issuer) to arrive at a subset of the cardholders. The filtering may be done based on one or more spending habits of the cardholders that are of interest to the issuer, and using the credit card input data set representing cardholder spending habits in the current time period. The resulting subset may represent a first cut at an audience for the proposed promotional marketing campaign. Then the promotion design computer 300 may further filter the first-cut subset based on the spending habit information contained in the historical payment network transaction input data set, to produce a further subset (i.e., a reduced subset of cardholders) that may be suitable for use as a highly and efficiently targeted audience for the proposed promotion. The resulting reduced subset, which also may be referred to as an “audience set”, may then be defined as the audience for the promotion as indicated at 408.

In addition to or instead of the type of filtering referred to above, the promotion design computer 300 may select the audience by using the promotional contact information and/or the non-transactional account information along with one or both of the current transaction data and the historical transaction data.

To provide a more concrete example of processing that may occur at 406 and 408, let it be assumed that one objective of the issuer with respect to the proposed promotion, or possibly the only or key objective, is to increase spending in the payment card accounts that are exhibiting low spending levels (say less than 75.00 USD per month). The first level of filtering then may simply be to identify all accounts in which this low-spending pattern is present in the credit card input data set (e.g., in all or part of the current time period). (In some embodiments, the resulting subset of cardholders may also exclude accounts that are entirely inactive.) The present inventors have recognized that the effectiveness and efficiency of the promotion may be significantly enhanced by further filtering the subset of cardholders based on the historical payment network transaction data for those cardholders. For example, and further assuming that the promotion is scheduled for at or near the year-end holiday season, the data for the historical period (i.e., last year) may be analyzed to identify cardholders whose spending pattern for their payment card accounts with the issuer typically increased from a low level at the holiday season. In this case, the identified cardholders from the second round of filtering may be excluded from the audience for the proposed promotion. That is, cardholders who spent at or above a threshold amount during some or all of the historical period may be excluded from the audience set. This may increase the efficiency of the promotion by not offering an incentive to spend more in the case of individual cardholders who are likely to increase their spending even in the absence of an incentive.

Paradoxically, for another promotion to increase spending in low-spend accounts, it may be desirable in the second filtering to exclude those who were also low spenders during part or all of the historical period. The notion is that those who have shown some propensity to spend more in the past may be better candidates to be encouraged to increase their spending from a current low level. From this point of view, those cardholders in the initial subset who were also in the low-spend category for all (or perhaps a substantial part) of the historical period should be excluded at the second filtering from the final audience set.

Another way in which filtering could be done in the context of a campaign to raise spending would be to take into account the extent to which the cardholders' spending is limited to one or a few categories of purchases. For example, at the first filtering based on current data, cardholders in a low-spend category could be selected for the initial subset. At the second filtering, based on historical network transaction data, the audience set may be established by excluding those whose categories of spending are not limited to a few categories, such as groceries and gasoline. The ultimate structure of the promotion could then be to provide an incentive for the targeted cardholders to spend outside of those few categories (e.g., for restaurants or travel). For example, the promotion could state as a prerequisite to earn an incentive that the cardholder must make a certain number and/or a certain dollar amount of purchases in one or more categories.

Referring again to FIG. 4, block 410, shown in phantom, represents processing that may be performed in some embodiments by the promotion design computer 300 to define attributes of the promotion in addition to the target audience for the promotion. At 410, if performed as part of the process of FIG. 4, the promotion design computer 300 may define an offer matrix for the promotion. The term “offer matrix” refers to a set of parameters for the promotion that may be presented to different segments of the target audience. For example, the offer matrix may be designed for two audience segments. One segment may be offered an incentive of a $10.00 gift card if the cardholder in question spends at least $200.00 with his/her payment card account by a certain date. (It will be understood that for this portion of the offer matrix, the requirement that the cardholder spend $200.00 is the prerequisite for receiving the incentive.)

For another segment of the audience, the offer provided may include an incentive of a $20.00 gift card if the cardholder in question spends at least $500.00 by a certain date. Again, the requirement that the cardholder spend at least $500.00 is the prerequisite for receiving the incentive.

In some embodiments, the segment of the audience receiving the first incentive/prerequisite pair in their offer may be those who are currently low spenders but who in the past spent at a level of about $200.00 per month according to the historical network transaction information. Contrastingly, the segment of the audience receiving the second incentive/prerequisite pair in their offer may be those who are currently low spenders but who in the past spent at a level of about $500.00 per month according to the historical network transaction information. It will be appreciated that the promotion design computer 300 may define the segments for the audience based on an analysis of the historical and/or current spending habits of the cardholders.

In other embodiments, the offer matrix may have more than two segments. In some embodiments, two or more segments may be offered the same incentive but different prerequisites may be stated for different audience segments. Prerequisites relating to spending in certain categories of purchases may also be stated.

In other embodiments, a human designer of the promotion may specify the offer matrix, matching it to audience segments defined by the promotion design computer 300 based on analysis of audience members' spending habits by the promotion design computer 300.

Continuing to refer to FIG. 4, at block 412 the promotion design computer 300 exports to another computer (e.g., the promotion execution block 212, FIG. 2) data that defines the promotion audience and or segments thereof, possibly with the parameters of the offer matrix as applicable to each audience segment. The actual execution of the promotion messaging may then be performed by the other computer.

The present inventors believe that basing audience selection on historical spending information and/or promotional contact information and/or non-transactional account information in addition to current information can lead to a 40% to 100% improvement in a desired marketing objective, as compared to a customary 20% increase that may be obtained by conventional audience selection practices.

The term “payment card network” or “payment network” is used to refer to a payment network or payment system such as the systems operated by MasterCard International Incorporated (which is the assignee hereof), or other networks that process payment transactions on behalf of a number of merchants, issuers and cardholders. The terms “payment card network data” or “network transaction data” are used to refer to transaction data associated with payment transactions that have been processed over a payment network. For example, network transaction data may include a number of data records associated with individual payment transactions that have been processed over a payment card network. In some embodiments, network transaction data may include information identifying a payment device or account, transaction date and time, transaction amount, and information identifying a merchant or merchant category. Additional transaction details may be available in some embodiments.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account or a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, in a computer, a data set representing payment card transactions of a set of cardholders during a current time period;
filtering data that represents the set of cardholders, by the computer, based on one or more spending characteristics exhibited by said set of cardholders and indicated by the payment card transactions during the current time period, to produce a subset of said cardholders; and
filtering data that represents the subset of cardholders, by the computer, based on one or more spending characteristics of said subset of cardholders during a historical time period that ended substantially prior to an ending point of the current time period, to produce an audience set of said cardholders.

2. The method of claim 1, wherein the one or more spending characteristics of said subset of cardholders during the historical time period are indicated by payment card transactions of said subset of cardholders during the historical time period.

3. The method of claim 1, wherein each member of the subset of cardholders spent less than a first threshold amount in the respective cardholder's payment card account during the current time period.

4. The method of claim 3, wherein each member of said audience set spent more than a second threshold amount during at least a portion of the historical time period.

5. The method of claim 3, wherein each member of said audience set spent less than a second threshold amount during at least a portion of the historical time period.

6. The method of claim 1, further comprising:
communicating a promotional offer to the audience set.

7. The method of claim 6, wherein the promotional offer includes offering an incentive to said audience set to increase a spending level in their payment card accounts.

8. A method comprising:
receiving, in a computer, a plurality of data sets relating to a set of cardholders, the plurality of data sets comprising:
at least one payment card account transaction data set;
a non-transactional account information data set; and
a promotion contact information data set; and
selecting, by the computer, a subset of the set of cardholders to be an audience for a promotional offer, said selecting based on data from all of said plurality of data sets.

9. The method of claim 8, wherein the at least one payment card account transaction data set includes a current card account transaction data set and a historical time period transaction data set.

10. The method of claim 9, wherein said selecting includes:
selecting, by the computer, a subset of said set of cardholders based on one or more spending characteristics exhibited by said subset and indicated by the payment card transactions during a current time period represented by said current card account transaction data set; and
reducing, by the computer, said subset of cardholders, based on one or more spending characteristics of said subset of cardholders during a historical time period that ended substantially prior to an ending point of the current time period.

11. The method of claim 8, wherein the non-transactional account information data set includes data indicative of at least one of (a) current account balance, (b) current credit limit, and (c) age of account.

12. The method of claim 8, wherein the promotion contact information includes, for at least some of the set of cardholders, a previous date on which a promotional offer was presented to a respective one of the cardholders.

13. The method of claim 8, wherein the promotional offer includes offering an incentive to said audience to increase a spending level in their payment card accounts.

14. A method comprising:
receiving, in a computer, a first data set representing payment card transactions of a set of cardholders during a current time period;
receiving, in the computer, a second data set representing payment card transactions of the set of cardholders during a historical time period that ended substantially prior to an ending point of the current time period; and
defining a promotional campaign based on spending characteristics of said set of cardholders;
wherein:
the promotional campaign has a plurality of attributes, the attributes of the promotional campaign including (a) an audience for the promotional campaign, (b) an incentive, and (c) a prerequisite for earning the incentive; and
the computer defines at least one of said attributes of the promotional campaign based on said spending characteristics of said set of cardholders during both the current time period and the historical time period.

15. The method of claim 14, wherein the computer defines the audience for the promotional campaign.

16. The method of claim 15, wherein the computer defines the audience for the promotional campaign based on cardholder spending characteristics during the current and historical time periods.

17. The method of claim 16, wherein cardholders are included in the audience if they exhibited low spending habits in the current time period and they exhibited spending habits that were not low spending habits during at least a portion of the historical time period.

18. The method of claim 16, wherein cardholders are included in the audience if they exhibited low spending habits in the current time period and they did not exhibit seasonally increased spending habits during the historical time period.

19. The method of claim 14, wherein the prerequisite for earning the incentive includes spending at least a threshold amount with a particular payment card account during a defined future period of time.

20. The method of claim 14, wherein the prerequisite for earning the incentive includes making at least a minimum number of purchase transactions in at least one predetermined category of purchases with a particular payment card account during a defined future period of time, and/or includes making at least a minimum monetary amount of purchase transactions in at least one predetermined category of purchases with particular payment card account during a defined future period of time.
